(19) United States
(12) Patent Application Publication
(10) Pub. No.: US 2025/0385523 A1
(43) Pub. Date: Dec. 18, 2025

(54) ALTERNATIVE ENERGY SYSTEMS FOR FOOD CARTS

(71) Applicants: Takehiro Yokoo, Misssion Viejo, CA (US); Jullian Yokoo, Misssion Viejo, CA (US)

(72) Inventors: Takehito Yokoo, Misssion Viejo, CA (US); Jullian Yokoo, Misssion Viejo, CA (US); Alex Spataru, Los Angeles, CA (US); Blake Christopher Hanson, Orange, CA (US); Alexander Stephen Moutoux, Los Angeles, CA (US); William Christopher Hurley, Los Angeles, CA (US); Ernest Harry Reed, Chino, CA (US)

(21) Appl. No.: 18/747,137

(22) Filed: Jun. 18, 2024

(51) Int. Cl. H02J 3/38; H01M 8/04082; H01M 8/04089; H01M 8/0656; H01M 10/46; H01M 16/00; H02J 3/32; H02S 10/10; H02S 10/20; H02S 20/23

(52) U.S. Cl. CPC H02J 3/38; H01M 8/04089; H01M 8/04201; H01M 8/0656; H01M 10/465; H01M 16/006; H02J 3/32; H02S 10/10; H02S 10/20; H02S 20/23; H01M 2220/20; H01M 2250/20; H02J 2300/24; H02J 2300/30

(57) ABSTRACT

Systems and methods for providing power to food carts using solar energy, battery storage, and hydrogen fuel cell energy. Systems comprise a plurality of solar panels arranged on a food cart, a battery system disposed in a basement, and a controller configured to monitor and control the power flow between the solar panels, the battery system, and the food cart, where the control system determines when hydrogen fuel cell energy is needed.

### FIELD OF THE INVENTION

The field of the invention is food carts that use alternative energy for overnight operation.

### BACKGROUND

The background description includes information that may be useful in understanding the present invention. It is not an admission that any of the information provided in this application is prior art or relevant to the presently claimed invention, or that any publication specifically or implicitly referenced is prior art.

Food carts are commonly used as mobile food delivery platforms for street vendors. They exist on college campuses, in event spaces, in urban areas, at schools, churches, and so on. Food cart vendors need to operate both during the day and at night. As sustainable energy becomes more prevalent and, in some cases, becomes legally mandated, food carts face a number of power supply challenges. Food carts generally cannot connect to a municipal power grid, which means that energy independence must be achieved for individual food carts. In general, this can be accomplished during the daytime using solar panels.

But solar panels generate no electricity at night. Using fossil fuels, small generators can be used to generate enough electricity to keep a food cart going, but if the goal of a food cart is to be both energy independent and free of fossil fuels, alternative solutions are needed. One such solution is to use a battery in conjunction with a solar system so that the battery can provide power when the solar panels cannot, but to continue operation throughout the night, battery weight becomes intolerable: food carts value mobility and should strive to be lightweight.

This gives rise to need for systems that can generate and store electricity through the day so that food carts can continue to function throughout the night. And because battery-only systems can be extremely heavy, such a system should be lightweight to maintain food cart portability. One way to solve both these problems is to create a hydrogen fuel cell hybrid system that uses both batteries and stored hydrogen to provide power to a food cart when the food cart's solar panels cannot.

Similar systems have been devised for homes and other stationary structures, but stationary structures are not subject to the same constraints as food carts, and thus there exists a need in the art for sustainable food cart systems that use a solar panels, hydrogen fuel cells, and batteries to enable round-the-clock operation.

### SUMMARY OF THE INVENTION

The present invention provides apparatuses, systems, and methods directed to food carats that use sustainable energy solutions to function day and night. In one aspect of the inventive subject matter, a sustainable food cart system comprises: a food cart comprising at least one appliance; solar panels coupled with the food cart; a battery system electrically connected to the solar panels; an electrolyzer electrically connected to the solar panels; a hydrogen tank coupled with the electrolyzer and configured to receive hydrogen created by the electrolyzer; and a hydrogen fuel cell configured to receive hydrogen from the hydrogen tank, wherein the hydrogen fuel cell is electrically connected to the battery system, where the battery system is electrically connected to the at least one appliance.

In some embodiments, the electrolyzer is electrically connected to the solar panels via the battery system. A solar converter can be disposed between the solar panels and the battery system and configured to convert electricity generated by the solar panels into a form that the battery system can receive. A power delivery converter can be disposed between the battery system and the at least one appliance and configured to convert electricity from the battery from direct current to alternating current. In some embodiments, the solar panels are disposed on a roof of the food cart.

In another aspect of the inventive subject matter, a sustainable food cart system comprises: a food cart; a set of solar panels; a battery system electrically connected to the solar panels; an electrolyzer electrically connected to the solar panels; a hydrogen tank coupled with the electrolyzer and configured to receive hydrogen created by the electrolyzer; and a hydrogen fuel cell coupled with the hydrogen tank and configured to receive hydrogen from the hydrogen tank, wherein the hydrogen fuel cell is electrically connected to the food cart, where the battery system is configured to provide electricity to the food cart.

In some embodiments, the electrolyzer is electrically connected to the solar panels via the battery system. The hydrogen fuel cell can be electrically connected to the food cart via the battery system. Some systems also include a solar converter disposed between the solar panels and the battery system, where the solar converter is configured to convert electricity generated by the solar panels into a form that the battery system can receive. In some embodiments, the system also includes a power delivery converter disposed between the battery system and the food cart that is configured to convert electricity from the battery from direct current to alternating current. The solar panels can be disposed on a roof of the food cart.

In another aspect of the inventive subject matter, a sustainable food cart system comprises: a food cart; a set of solar panels; a battery system electrically connected to the solar panels; an electrolyzer electrically connected to the battery system; a hydrogen tank coupled with the electrolyzer and configured to receive hydrogen created by the electrolyzer; and a hydrogen fuel cell coupled with the hydrogen tank and configured to receive hydrogen from the hydrogen tank, wherein the hydrogen fuel cell is electrically connected to the battery system, where the battery system is configured to provide electricity to the food cart.

In some embodiments, the system also includes a solar converter disposed between the solar panels and the battery system, where the solar converter is configured to convert electricity generated by the solar panels into a form that the battery system can receive. Some systems also include a power delivery converter disposed between the battery system and the food cart, where the power delivery converter is configured to convert electricity from the battery from direct current to alternating current. The solar panels can be disposed on a roof of the food cart.

One should appreciate that the disclosed subject matter provides many advantageous technical effects including a hybrid battery/hydrogen fuel cell energy system for food carts that balances performance with portability.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 shows a sustainable food cart system during daytime.

FIG. 2 shows the sustainable food cart system during nighttime, where the food cart runs on battery power.

FIG. 3 shows the sustainable food cart system during nighttime when the battery is depleted and a hydrogen fuel cell is used to generate electricity for the food cart.

FIG. 4 is a visualization showing how the system can transition from daytime to nighttime.

FIG. 5 shows how a hydrogen fuel cell creates electricity.

FIG. 6A thus shows a schematic of a sustainable food cart system.

FIG. 6B shows a sustainable food cart system that includes an auxiliary hydrogen tank.

FIG. 7 shows a schematic of an alternative sustainable food cart system.

FIG. 8 is a flowchart describing a configuration where solar panels are used to both power the electrolyzer and the food cart, and, when the battery depletes, hydrogen generated by the electrolyzer is used to generate electricity in the fuel cell.

FIG. 9 is another flowchart describing how sustainable food cart system can operate.

FIG. 10 is a modified version of the system shown in FIG. 9.

FIG. 11 shows a schematic where two food carts benefit from a single hydrogen fuel cell subsystem.

FIG. 12 is a graph showing system weights for sustainable food cart systems of the inventive subject matter.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, number ranges of any kind, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

Systems and methods of the inventive subject matter are directed to using alternative energy solutions to power food carts throughout the day and night. Embodiments use a combination of batteries, solar generation, and hydrogen fuel cells to create a food cart that is capable of round-the-clock function while requiring no—or minimal—time connected to an established energy grid. Embodiments described in this application solve problems facing existing standalone food cart systems (e.g., food cart systems that are not able to connect to an existing energy grid) by using a combination of batteries and hydrogen as energy storage mediums. Systems of the inventive subject matter are improvements over similar systems that use, e.g., only batteries in that systems described in this application are significantly lighter weight, which improves mobility—an important quality for food carts that must be manual moveable by a single person in many instances.

Solar power is used to charge a batter and to power an electrolyzer that creates hydrogen that is stored for use by a fuel cell to generate electricity when the battery level drops below a threshold. Embodiments can also implement control systems using different sensors and actuators to control how to balance battery charging, H₂ generation, and power delivery to appliances and infrastructure included in a given food cart. Embodiments are therefore sustainable, create zero CO₂ emissions, and are capable of powering food carts using a combination of solar energy, battery power, and hydrogen fuel cells. The end result is a system that is clean, efficient, reliable, and portable.

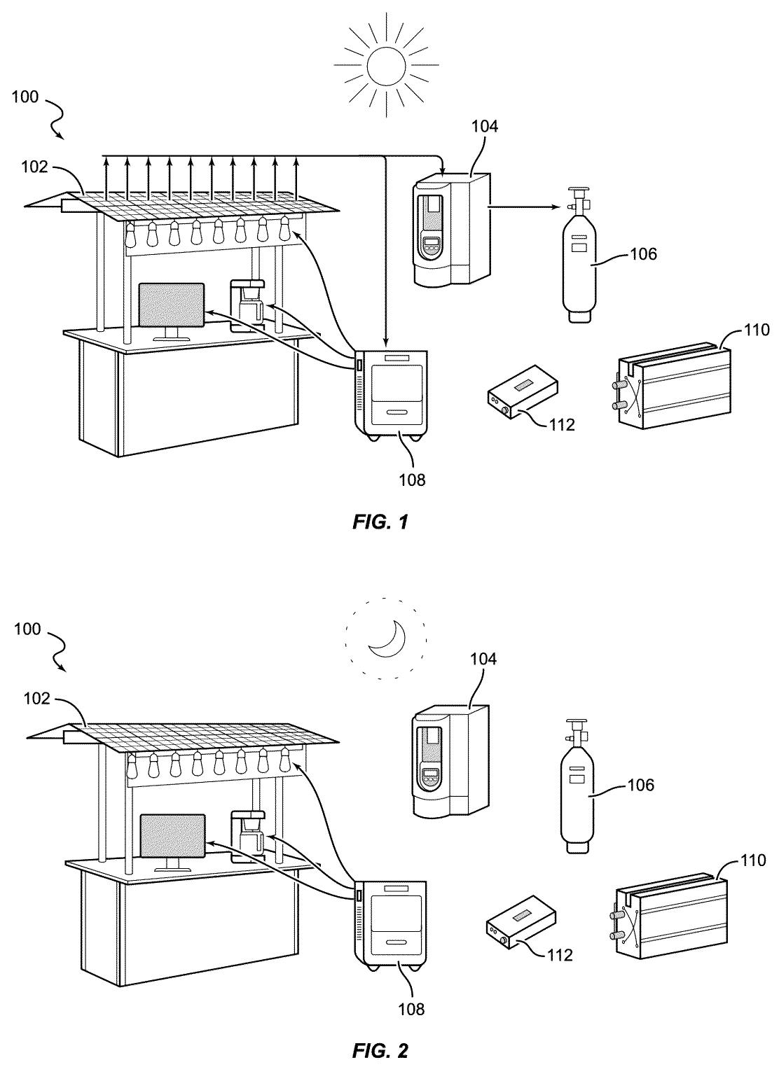

FIGS. 1 and 2 show an example sustainable food cart system of the inventive subject matter during the daytime (FIG. 1) and during nighttime (FIG. 2). The food cart system shown in FIGS. 1 and 2 includes a food cart 100 having solar panels 102. Solar panels 102 are shown on the roof of food cart 100, though solar panels 102 can be positioned relative to the rest of food cart 100 in a number of different ways without deviating from the inventive subject matter. For example, in some embodiments, solar panels 102 can be manually deployed by setting them down in an array near food cart 100. In some embodiments, food cart 100 can be coupled with an existing solar panel system (e.g., a solar panel system that powers a building that the food cart is set up near).

The sustainable food cart system also includes an electrolyzer 104, a hydrogen tank 106, a hydrogen fuel cell 110, a fuel cell converter 112, and a battery system 108. Each of these components should be understood to also include supporting parts, components, and subsystems that makes each of these components function properly within the context of the sustainable food cart system. For example, wiring connecting the solar panels to the solar converter are not explicitly described but should be understood as necessary. The sustainable food cart system is configured such that power generated by solar panels 102 can be used to charge battery system 108 and to carry out electrolysis using electrolyzer 104. Battery system 108 can include one or more batteries along with supporting components to make the unit function as described in this application. Embodiments can additionally feature control systems to bring to life all the functions described and implied in this application.

FIG. 1 shows the sustainable food cart system during daytime. Sunlight reaches solar panels 102, which in turn generates electricity. Electricity generation is represented by arrows pointing upward away from solar panels 102. Electrical pathways are shown connecting solar panels 102 with battery system 108 and electrolyzer 104. During the day, solar panels 102 are represented as generating that is delivered to both electrolyzer 104 and battery system 108. How electricity passes from solar panels 102 to electrolyzer 104 and battery system 108 is described in more detail below, and although this figure represents electricity passing independently to battery system 108 and electrolyzer 104, it should be understood that electricity may pass to electrolyzer 104 only after passing through battery system 108. Once electricity reaches electrolyzer 104, electrolyzer 104 creates hydrogen via electrolysis, and hydrogen created by electrolysis is stored in hydrogen tank 106. Thus, energy can pass from solar panels 102 either sequentially, or simultaneously, to electrolyzer 104 and battery system 108.

FIG. 2 shows the sustainable food cart system during nighttime, where battery system 108 handles providing power to food cart 100. In this context, “nighttime” is synonymous with conditions in which solar panels 102 no longer receive enough light to generate sufficient power to charge battery system 108, to power electrolyzer 104, or to otherwise power food cart 100. This can occur during nighttime or during periods of heavy cloud cover or any other condition in which solar panels 102 can no longer generate power. Thus, food cart 100 must be powered by energy stored in either the battery system 108 or as hydrogen generated by electrolyzer 104. In FIG. 2, battery system 108 is used to power food cart 100, as battery system 108 is generally discharged before supplying hydrogen from hydrogen tank 106 to hydrogen fuel cell 110 to generate electricity.

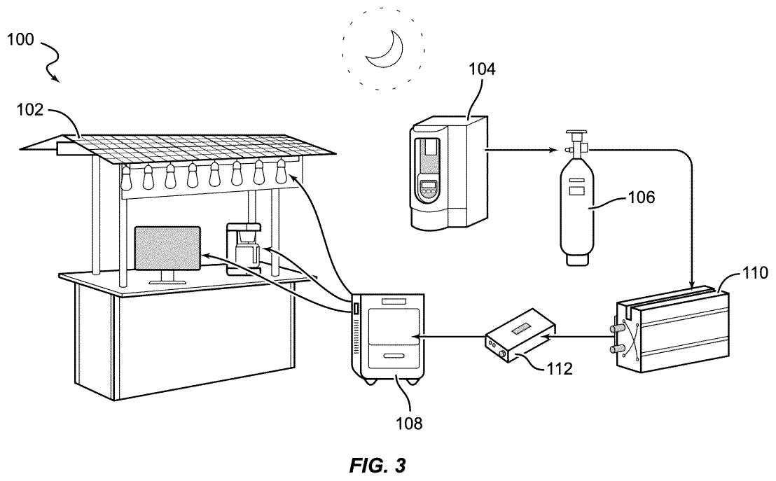

Once battery system 108 is discharged below a threshold charge level, hydrogen stored in hydrogen tank 106 can be used by hydrogen fuel cell 110 to generate electricity so that food cart 100 can continue to operate past a time at which its battery system would otherwise fail (e.g., fully discharge). FIG. 3 thus shows the sustainable food cart system during nighttime when battery system 108 is depleted and hydrogen is being released from hydrogen tank 106 to generate electricity in hydrogen fuel cell 110. Electricity generated in hydrogen fuel cell 110 travels to battery system 108 via fuel cell converter 112. Fuel cell converter 112 converted electricity generated by hydrogen fuel cell 110 into a form that battery subsystem can handle.

In some situations, electricity generated by hydrogen fuel cell 110 can bypass battery system 108 to directly power food cart 100. In situations where more electricity is generated by hydrogen fuel cell 110 than is needed to power food cart 100, excess electricity can be used to charge batteries in battery system 108. In general, modulating how much electricity hydrogen fuel cell 110 generates such that electricity supply always matches electricity demand would maximize efficiency, but situations where electricity demand increases more sharply than supply can match would result in a nonfunctional (or poorly functioning) food cart. Thus, by using electricity generated by hydrogen fuel cell 110 to charge batteries in battery system 108, battery system 108 can provide supplemental power to satisfy demand, including spikes resulting from appliance use.

In another configuration, electricity from hydrogen fuel cell 110 is used only to charge batteries in battery system 108, and battery system 108 is solely responsible for providing power to food cart 100. In this configuration, the need to modulate electricity generation from hydrogen fuel cell 110 is diminished (or even unnecessary in some embodiments). Instead, hydrogen fuel cell 110 is configured to generate a set amount of power that goes to battery system 108 to charge its batteries. Because power demands from food cart 100 are not constant, during times when demand is low, the batteries charge. During times when demand is high, batteries discharge. On aggregate, batteries should be charging more than discharging, or, at a minimum, maintaining a level charge. If batteries are in an aggregate discharging state, then food cart 100 will not be able to function properly. One way to handle charging and discharging of battery system 108 is to set a maximum charge level and a minimum charge level. When battery system 108 exceeds a maximum charge level, hydrogen fuel cell 110 ceases to generate electricity and food cart 100 operates on battery power. Once battery system 108 falls below a minimum charge level, hydrogen fuel cell 110 begins generating electricity again to recharge battery system 108. Maximum charge level can range from 50% to 100% and minimum charge level can range from 0% to 50%. More typically, a maximum charge level can be 80% and a minimum charge level can be 20%. These levels help maintain good battery health by never fully charging the batteries and also ensure a food cart is never without electricity by beginning to charge again before the batteries are fully depleted.

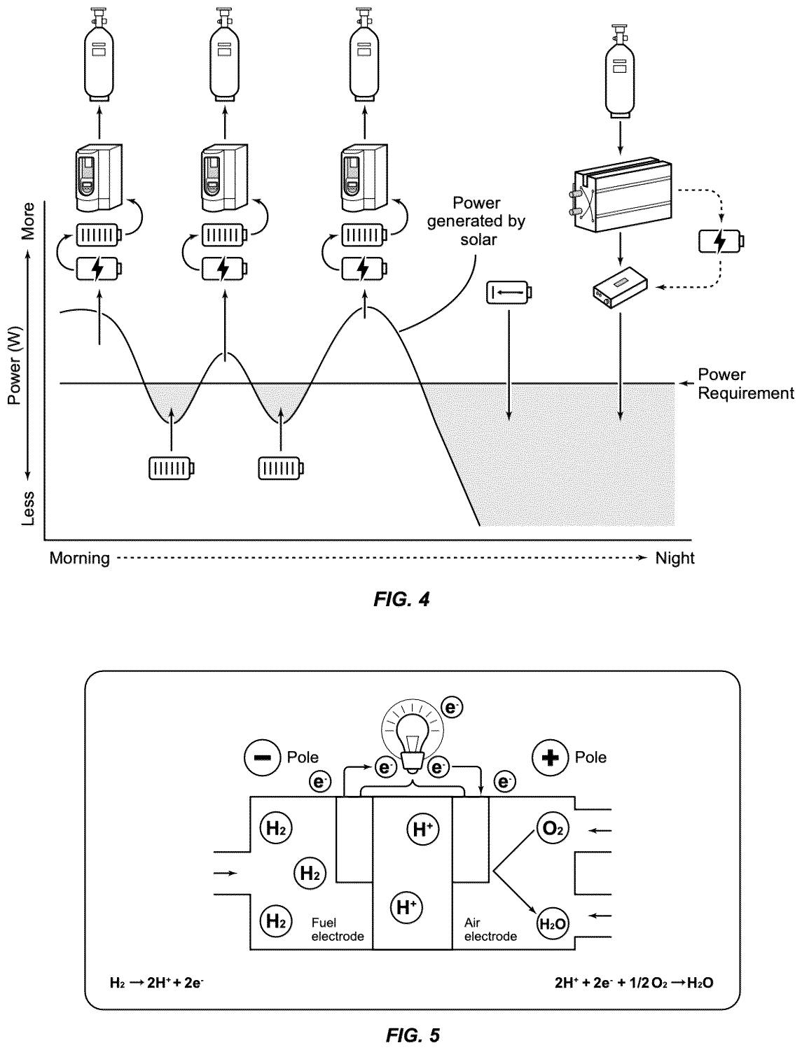

FIG. 4 is a visualization showing how a system of the inventive subject matter can transition from daytime to nighttime. The visualization is expressed as a graph of power versus time. A horizontal line represents a food cart's average power requirement. In reality, a food cart's power requirement can be highly variable based on appliance usage, number of appliances, and so on, but the concept remains the same. Another line represents power generated by the system's solar panels. When solar power generation exceeds the food cart's power requirement, such as in the first portion of the graph, excess power can be used for battery charging. And once a system's batteries are fully charged (e.g., charged beyond a charge level threshold), excess power can go to the electrolyzer where it is used to carry out electrolysis to create hydrogen.

As power generation from solar panels dips below a food cart's power requirement level, the battery system provides supplemental power. For example, if clouds pass overhead, a food cart's solar panels operate in a diminished capacity and additional power is needed to meet the food cart's power requirement. In these types of situations, a system's battery system kicks in to provide power to supplement whatever power the solar panels are still generating, if any. Once solar panels are again able to generate power in excess of the food cart's power needs, the system's batteries can be recharged and electrolysis can continue. As mentioned above, a food cart's actual power requirement can change over time based on, e.g., how many and which appliances are in use. Thus, whether a food cart's solar panels are over-or under-producing electricity can be a function not only of cloud cover, but also of a food cart's instantaneous power needs.

As the graph transitions from day to night, the solar panels gradually produce less electricity until they cease to produce any electricity at all. Once the solar panels are unable to meet the food cart's power requirement, the battery system kicks in to provide energy to ensure power is available for the food cart to continue operation without interruption. This causes the batteries to discharge, and, once the batteries are discharged beyond a certain threshold (e.g., down to below 20%, as low as 0%, or anywhere in between), the hydrogen fuel cell must begin generating power. As discussed above, power from the hydrogen fuel cell can be used to power the food cart, to charge the food cart's batteries, or both, as needed.

FIG. 5 shows how a hydrogen fuel cell creates electricity. Hydrogen fuel cells work by converting hydrogen gas into electricity through a chemical reaction. In a typical hydrogen fuel cell, hydrogen gas (H₂) is fed into the anode side (the left side of the figure) of the fuel cell, while oxygen (O₂) from the air is fed into the cathode side. At the anode, a catalyst, often made of platinum, helps to split the hydrogen molecules into protons and electrons. The protons pass through a proton exchange membrane to the cathode side, while the electrons travel through an external circuit, creating an electric current, which can be used to power a food cart and charge batteries. At the cathode, the protons, electrons, and oxygen combine to form water, which is the only byproduct of the process.

This process is environmentally friendly as it only emits water vapor and heat, making it a clean alternative to fossil fuels. The efficiency of hydrogen fuel cells is higher than that of traditional combustion engines, which are often used to generate electricity when access to a grid or other source of energy is not available.

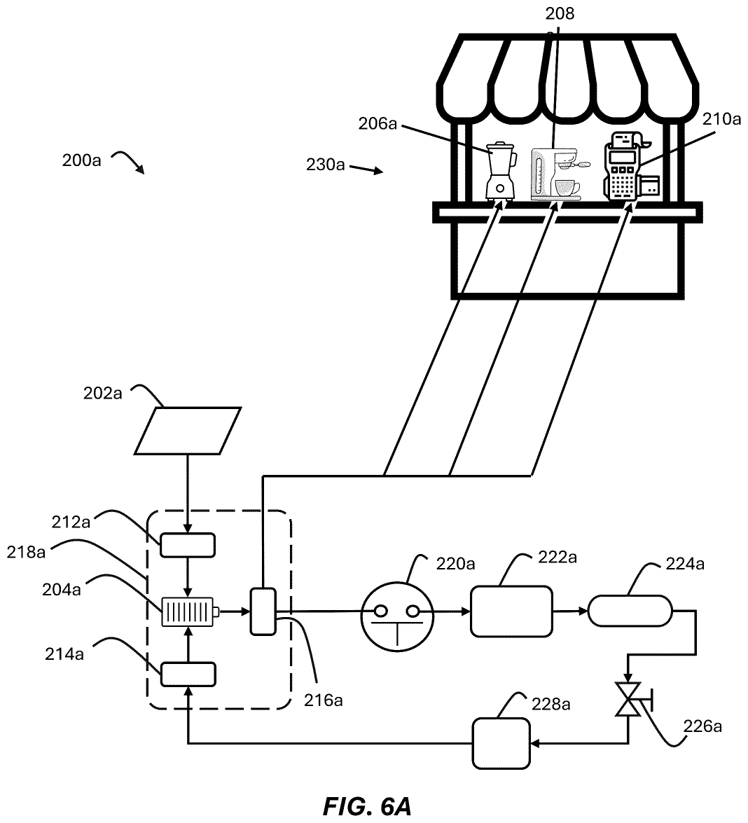

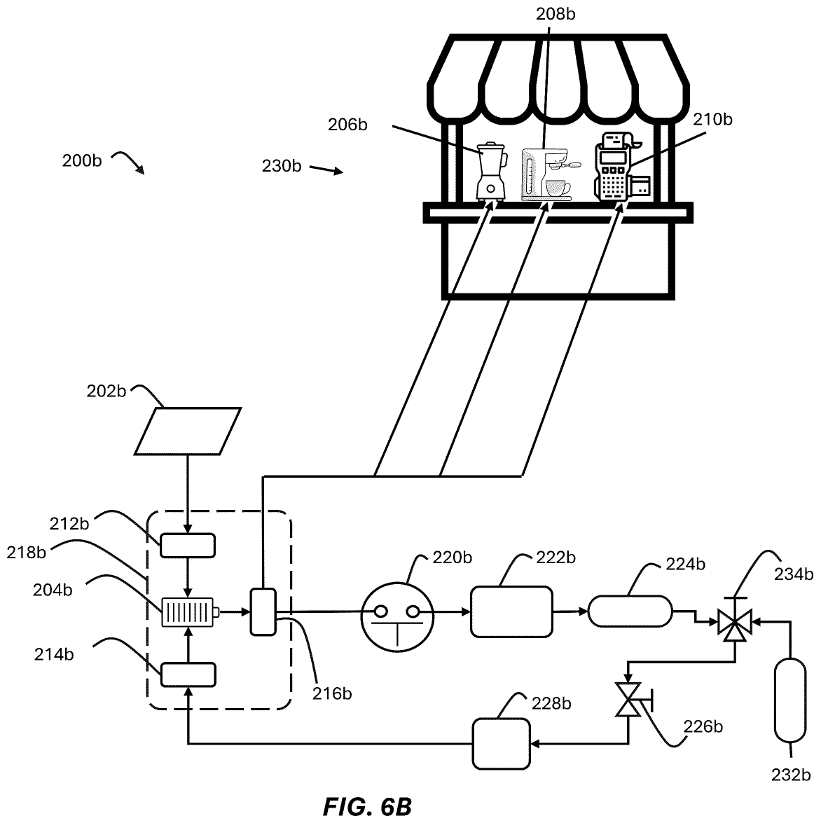

FIGS. 6A and 6B show two possible system configurations, where FIG. 6B features an external (to the system) hydrogen tank. Building in access to an external hydrogen tank can ensure that, even if the hydrogen tank coupled with the electrolyzer (in other words, included with a food cart system) runs out of hydrogen, the food cart will not lose power because the external hydrogen tank can provide hydrogen to the fuel cell. FIG. 6A thus shows a schematic of a sustainable food cart system 200a. It shows solar panels 202a connected to power subsystem 218a. Power subsystem 218a includes solar converter 212a, battery 204a, fuel cell converter 214a, and power delivery converter 216a. Each of these converters is modeled out separately from its surrounding components for ease of understanding, though it should be understood that any of the converters discussed in this application can be incorporated into one or more systems or subsystems that each converter is intended to function in cooperation with.

Power generated by solar panels 202a is thus delivered to solar converter 212a. Solar converter 212a converts power generated by the solar panels into a form that can be used to charge battery 204a. And although battery 204a is represented as a single battery, battery 204a can comprise an array of batteries that work together to supply power to food cart 230a. Similarly, fuel cell converter 214a receives power generated by fuel cell 228a and converts it into a form that can be used to charge battery 204a.

Battery 204a is configured to deliver power to food cart 230a via power delivery converter 216a. Power delivery converter 216a converts direct current supplied by battery 204a into alternating current that is useable by the food cart (e.g., 120V, 220V, or whatever voltage is commonly used in the geographic region in which the food cart is deployed). Power delivered to food cart 230a can then be used to run various appliances. In the case of FIGS. 6A and 6B, example appliances include a blender 206a, a coffee machine 208a, and a point-of-sale system 210a (all examples of appliances that can be used on a food cart of the inventive subject matter).

In the system shown in FIGS. 6A and 6B, energy stored in battery 204a is also used to deliver power to electrolyzer 222a. This system is thus configured such that there is no direct connection between solar panels 202a and electrolyzer 222a. When electrolyzer 222a is powered, it converts water into hydrogen and oxygen, and hydrogen is captured in hydrogen tank 224a. Power delivery to electrolyzer 222a is toggled by switch 220a. Switch 220a can be electronically controlled to facilitate implementation of a control system that controls where power should be delivered within the system according to different system conditions (e.g., day, night, cloud cover, battery level, etc.). Hydrogen stored in hydrogen tank 224a can then be used by fuel cell 228a to generate electricity. Valve 226a is disposed between a line connecting hydrogen tank 224a and fuel cell 228a. Valve 226a can be electronically controlled or manually controlled. When valve 226a is open, hydrogen can flow from hydrogen tank 224a to fuel cell 228a, allowing fuel cell 228a to generate electricity.

The system is thus configured such that power from all sources (e.g., solar or fuel cell) can be delivered to battery 204a, and battery 204a can then deliver power to food cart 230a. In some embodiments, electronics in power subsystem 218a allow for electricity to bypass battery 204a. In such cases, power from solar panels 202a can pass to solar converter 212a, which then bypasses battery 204a to send converted power to power delivery converter 216a. In some embodiments, solar power can be delivered directly to power delivery converter 216a (e.g., when battery 204a is fully charged and no need exists to convert power from the solar panels into a form that is needed to charge battery 204a).

In a similar way, power from fuel cell 228a can bypass battery 204a. In such cases, power from fuel cell 228a can pass to fuel cell converter 214a, which then bypasses battery 204a to send converted power to power delivery converter 216a. In some embodiments, fuel cell power can be delivered directly to power delivery converter 216a (e.g., when battery 204a is fully charged and no need exists to convert power from the fuel cell into a form that is needed to charge battery 204a).

FIG. 6B, as mentioned above, shows a sustainable food cart system 200b that includes an auxiliary hydrogen tank 232b. Auxiliary hydrogen tank 232b can be, e.g., a modular hydrogen tank system or external source of hydrogen of any kind that exists as a backup to hydrogen tank 224b. In some embodiments, auxiliary hydrogen tank 232b can actually be an infrastructure-level connection to a hydrogen supply. Auxiliary hydrogen tank 232b is not filled by electrolyzer 222b and is instead can be filled elsewhere and delivered as filled and functional standalone unit. Auxiliary valve 234b is included to facilitate control over when hydrogen stored in auxiliary hydrogen tank 232b can reach fuel cell 228b. Although auxiliary valve 234b is drawn with valve 226b downstream between auxiliary valve 234b and fuel cell 228b, this configuration is not a requirement. Instead, auxiliary valve 234b can be positioned anywhere in the system so long as it can deliver hydrogen to fuel cell 228b. The auxiliary hydrogen tank configuration shown in FIG. 6B can be incorporated into any embodiment described in this application.

In some embodiments, auxiliary hydrogen tank 232b can comprise an easily swappable hydrogen fuel tank or set of tanks. As hydrogen fuel cell technology improves and becomes more popular, the need for hydrogen also grows. But because not every person or business needs an electrolyzer, services may exist that separate hydrogen from oxygen and then delivery that hydrogen on demand.

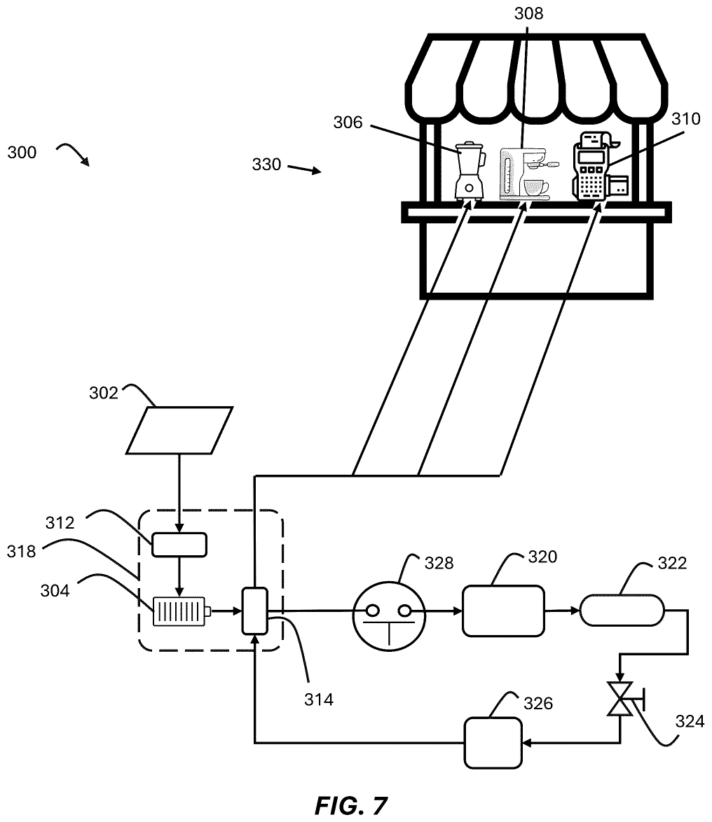

FIG. 7 shows a schematic of an alternative sustainable food cart system 300. This embodiment includes many of the same components, including solar panels 302, a power subsystem 318, a switch 328, an electrolyzer 320, a hydrogen tank 322, a valve 324, and a fuel cell 326. The schematic also represents food cart 330 with representative appliances including a blender 306, a coffee machine 308, and a point-of-sale system 310. One difference between this system and the systems described above is that power subsystem 318 does not include a fuel cell converter. Instead, this system is configured such that energy generated by fuel cell 326 bypasses battery 304 and passes directly to power delivery converter 314. Power delivery converter 314 ensures that power received from fuel cell 326 is converted into a form that is useable by food cart 330. In system 300, battery 304 is charged only by solar panels 302. Solar panels 302 deliver power to solar converter 312 that converts the power into a form that is capable of charging battery 304.

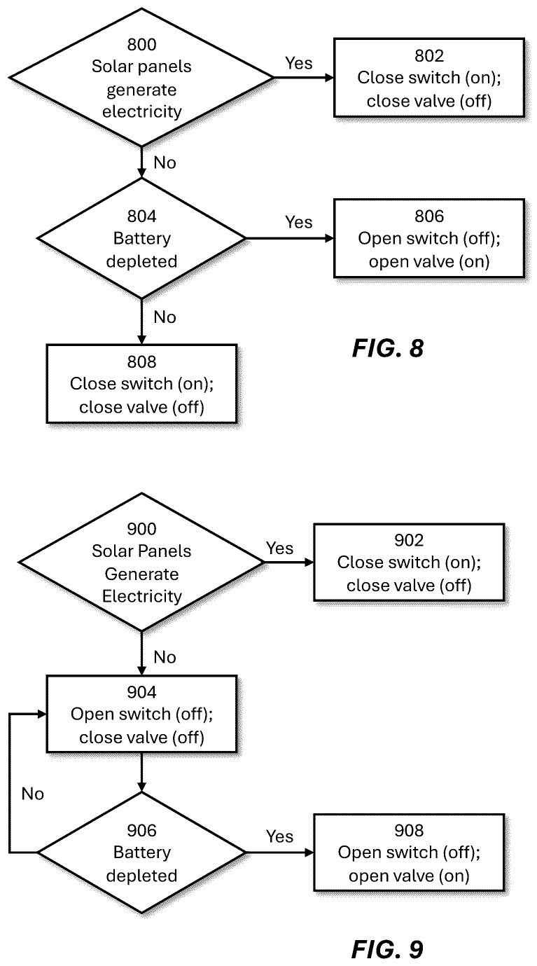

FIGS. 8-10 are flowcharts describing how systems of the inventive subject matter can be configured to function. FIG. 8 is a flowchart describing a configuration where solar panels are used to both power the electrolyzer and the food cart, and, when the battery depletes, hydrogen generated by the electrolyzer is used to generate electricity in the fuel cell.

In step 800, the system first checks whether the solar panels are generating electricity. This determination can be made by, e.g., using one or more sensors to measure current or voltage that the solar panels are generating. If the solar panels are generating electricity, then in step 802 the switch is moved to an “on” position, which allows electricity to flow to the system's electrolyzer from the systems battery while the system's battery receives electricity from the solar panels. This configuration may occur when, e.g., the system's battery is filled beyond a charge level threshold (e.g., the battery is considered full), or when the solar panels generate enough electricity to charge the battery and run the electrolyzer at the same time, where energy stored in the battery can also be used to run the food cart. The system's valve is thus moved to an “off” position in step 802 because electricity from the fuel cell is not needed.

But if the solar panels are not generating electricity, the system then checks, in step 804, whether the battery is depleted. If the battery is depleted (e.g., the battery is discharged below a charge level threshold), then the switch opens to an “off” configuration to prevent the battery from powering the electrolyzer, and the valve is opened to allow hydrogen to flow to the fuel cell so that the fuel cell can generate electricity. If the battery is not depleted, then the switch is closed to an “on” position and the valve is closed so that the battery can run the electrolyzer (e.g., while solar power continually charges the battery).

FIG. 9 is another flowchart describing how sustainable food cart system can operate. In step 900, the system checks whether the solar panels are generating electricity. If the system detects that the solar panels are generating electricity, then in step 902 the switch is closed to the “on” position such that power is delivered to the electrolyzer and the valve is closed so that the fuel cell does not receive hydrogen or generate electricity. But if the solar panels are not generating electricity, then in step 904 the switch is opened to the “off” position to prevent power being delivered from the battery to the electrolyzer and the valve is moved to the off position. This configuration essentially operates as a “while” loop, where the system monitors battery charge in step 906. As long as battery charge level remains above a charge level threshold, the switch stays open (off) and the valve stays closed (off), resulting in the food cart operating solely on battery power. Once the battery charge level falls below a threshold, the system in step 908 leaves the switch open but opens the valve so that the fuel cell receives hydrogen and begins to generate electricity.

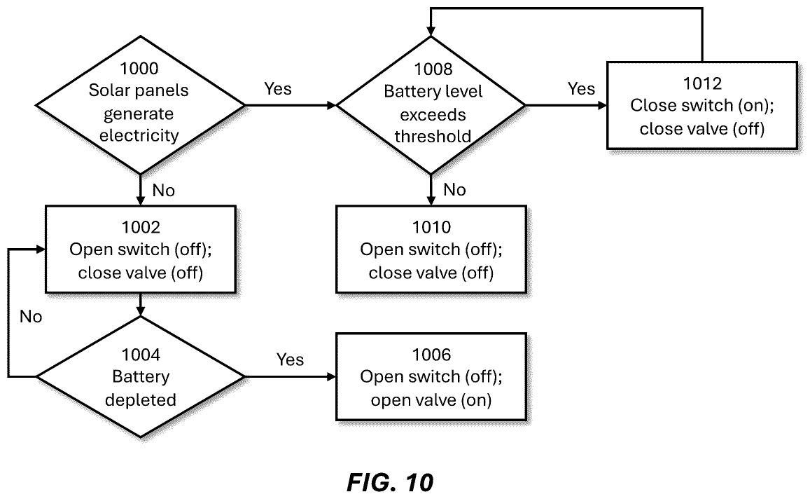

FIG. 10 is a modified version of the flowchart in FIG. 9. Steps 1000-1006 are the same as those described in FIG. 9. The difference, here, is that if the solar panel is generating electricity, then in step 1008 the system checks the battery's charge level to see if it exceeds some threshold. The threshold value can be set at any desired level, and the threshold value is then used to determine whether battery power can be used to power the electrolyzer. Thus, if the battery's charge level exceeds the threshold, then in step 1012 the switch is closed and the valve is left off, thus powering the electrolyzer to generate hydrogen. And if the battery's charge level does not exceed the threshold, then the switch is opened and the electrolyzer is left unpowered.

The threshold battery charge level for step 1008 can depend on a number of factors, including battery capacity, battery cycle life, and so on. It may be desirable, for example, to keep the battery below 100% to preserve battery health, and by allowing excess power to be used to generate hydrogen instead of allowing it to charge the battery to 100%, the battery's health can be preserved. This configuration results in a system that charges a battery as a first priority and then produces hydrogen as a second priority. Battery charge thresholds can be between 30%-100%, though lower thresholds can also be selected in instances where, e.g., a high-capacity battery is used and a small percent of battery change would be sufficient for purposes of the system in which the high-capacity battery is deployed.

Thus, in step 1000, the system checks if its solar panels are generating electricity. If the solar panels are not generating electricity, the switch is opened to prevent electricity from flowing to the electrolyzer, and the hydrogen tank valve is set to the closed position (or, more accurately, left in a close position until making key determinations in subsequent steps) per step 1002. From step 1002, the system then checks whether the battery is depleted (e.g., it has fallen below a charge threshold) in step 1004. If the battery is not depleted, then the system returns to step 1002 and maintains that state, which results in the food cart being powered by the battery. If the system detects in step 1004 that the battery is depleted then in step 1006 the switch remains opened and the valve is changed from a closed position to an open position to allow hydrogen to flow to the fuel cell. Thus, when battery charge level indicates the battery is depleted, the fuel cell kicks in to begin supplying power to the food cart.

As discussed above, whether a battery is considered depleted according to any embodiment of the inventive subject matter described in this application is a matter of thresholds. In some embodiments, a system may wait for a battery to completely drain, but that can result in power interruptions in the time it takes for the fuel cell to begin delivering power. Thus, in some embodiments, a system's battery is considered depleted when the battery's charge level drops below some threshold. For example, a battery can be considered depleted when its charge level (state of charge) falls to a value between 0% and 25%. By leaving some amount of battery charge when the system begins to use the fuel cell to generate power, the system ensures the food cart does not experience any interruption in power delivery.

Systems of the inventive subject matter represent improvements over systems that implement battery-only solutions at least because systems of the inventive subject matter are significantly lighter weight that comparable battery-only systems. So while a battery-only solution may be more efficient or less expensive (at least for now), battery-only systems with batteries that are large enough to provide overnight power to a food cart would weigh too much to make them practicable. Food carts are portable and thus reducing total weight is important to maintain food cart portability and overall functionality for their intended use.

For example, for a food cart that consumes about 630 Wh/hr of energy, and assuming 8 hours of energy is needed for the food cart to last through nighttime operation, then the food cart would need around 5 kWh of energy storage capacity to get through nighttime operation. In general, lithium-ion battery health and performance is best maintained when charge level (state of charge) is kept between 20% and 80%, which means that a battery-only system would need an 8.3 kWh battery to be capable of delivering 5kWh of energy over an 8-hour period (without falling below 20% or rising about 80% charge level).

An 8.3 kWh capacity lithium-ion battery would weigh about 90 kg. By comparison, a pure hydrogen fuel cell system capable of storing 8.3 kWh of energy would weigh around 58 kg. A hydrogen fuel cell system includes a fuel cell, an electrolyzer, and a hydrogen tank. A fuel cell (or set of fuel cells) capable of generating 600 W weighs around 22.5 kg. An electrolyzer that is designed to generate enough hydrogen for 5 kWh of fuel cell power output during daytime operation would weigh around 23.4 kg. And a hydrogen tank capable of storing around 242 g of hydrogen, which would be sufficient to power a fuel cell (or set of fuel cells) to generate 5 kWh of energy (assuming a fuel cell efficiency of 50%), would weigh around 12 kg. Given a pressure requirement of around 200 psi, such a hydrogen tank could be made from, e.g., polyurethane and have a capacity of around 270 L. These components together come to around 58 kg.

In a hybrid system having both a battery and a fuel cell system, the system can benefit from the efficiencies of a battery system while still benefitting from the weight savings enjoyed by a hydrogen fuel cell system. For example, if a 0.5 kWh battery (having a weight of about 6 kg) is added to the hydrogen fuel cell system described above, the overall weight increases to around 64 kg, which is about 30% lower than a battery-only system.

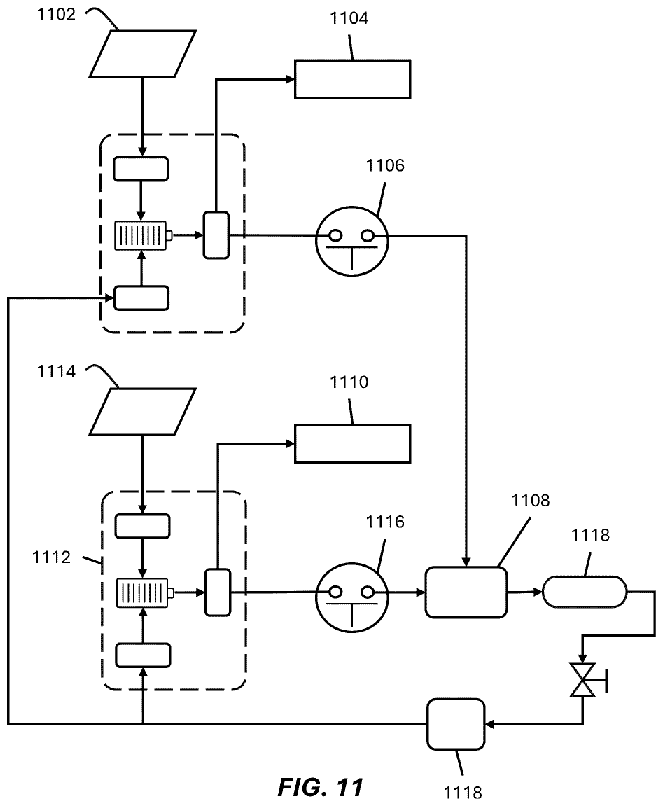

In some embodiments, multiple sustainable food cart systems of the inventive subject matter can use the same electrolyzer to fill one or more hydrogen tanks. FIG. 11 shows a schematic where two food carts benefit from a single hydrogen fuel cell subsystem. Solar panels 1102 provide electricity to power subsystem 1100, where power subsystem comprises the same components as described above regarding FIGS. 6A and 6B (e.g., at least a solar converter, a battery, a fuel cell converter, and a power delivery converter). Power is delivered from power subsystem 1100 to food cart 1104. Power can also be delivered from power subsystem 1100 to electrolyzer 1108 via switch 1106.

Simultaneously, food cart 1110 receives power from power subsystem 1112, which in turn receives power from solar panels 1114. Power subsystem 1112 can deliver power to electrolyzer 1108 via switch 1116. Thus, electrolyzer 1108 can receive power from one or both power subsystems, where each power subsystem is associated with a different food cart. Electrolyzer 1108 can therefore generate hydrogen to fill hydrogen tank 1118 by using power from several different sources. And when hydrogen is used by fuel cell 1120 to generate electricity, that electricity is delivered to one or both of the power subsystems for the two different food carts, depending on whether each individual cart needs power from the fuel cell. Such a configuration can further reduce aggregate weight of the two food carts by allowing them to share hydrogen fuel cell components and related structures.

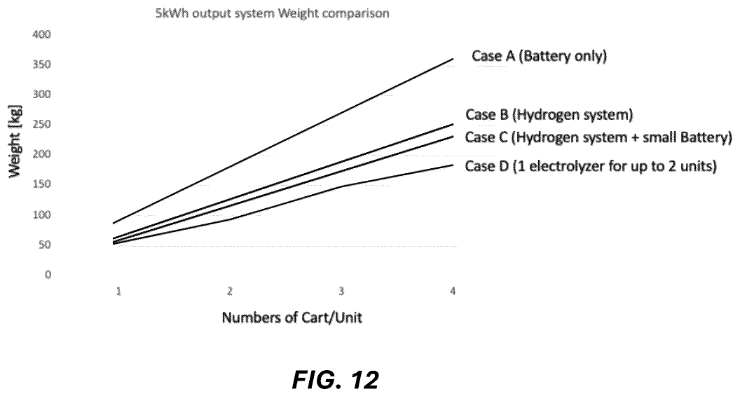

FIG. 12 is a graph showing system weights for sustainable food cart systems of the inventive subject matter. The x-axis corresponds to a number of food carts, and the y-axis is weight. The graph shows that battery-only systems are the heaviest systems and increase in weight the most quickly as a function of number of carts, while systems that share fuel cell systems are the lightest weight and increase in weight the slowest as a function of number of carts.

Data used to generate the graph shown in FIG. 12 is included in Table 1, below.

TABLE 1

| | Cart Units | | | | | | | |
|---|---|---|---|---|---|---|---|---|
| | 1 unit | | 2 units | | 3 units | | 4 units | |
| Energy storage for 630 | 5 | kWh | 10 | kWh | 15 | kWh | 20 | kWh |
| W × 8 hours | | | | | | | | |
| Battery system weight | 90 | kg | 180 | kg | 270 | kg | 360 | kg |
| Hydrogen system weight | 58 | kg | 116 | kg | 174 | kg | 232 | kg |
| Hydrogen + small battery | 63 | kg | 126 | kg | 189 | kg | 252 | kg |
| system weight | | | | | | | | |
| Shared fuel cell system | 58 | kg | 92 | kg | 150 | kg | 184 | kg |
| for two units | | | | | | | | |

Thus, specific systems and methods directed to sustainable food cart systems have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A sustainable food cart system comprising:
a food cart comprising at least one appliance;
solar panels coupled with the food cart;
a battery system electrically connected to the solar panels;
an electrolyzer electrically connected to the solar panels;
a hydrogen tank coupled with the electrolyzer and configured to receive hydrogen created by the electrolyzer;
a hydrogen fuel cell configured to receive hydrogen from the hydrogen tank, wherein the hydrogen fuel cell is electrically connected to the battery system; and
wherein the battery system is electrically connected to the at least one appliance.

2. The system of claim 1, wherein the electrolyzer is electrically connected to the solar panels via the battery system.

3. The system of claim 1, further comprising a solar converter disposed between the solar panels and the battery system, wherein the solar converter is configured to convert electricity generated by the solar panels into a form that the battery system can receive.

4. The system of claim 1, further comprising a power delivery converter disposed between the battery system and the at least one appliance, wherein the power delivery converter is configured to convert electricity from the battery from direct current to alternating current.

5. The system of claim 1, wherein the solar panels are disposed on a roof of the food cart.

6. A sustainable food cart system comprising:
a food cart;
a set of solar panels;
a battery system electrically connected to the solar panels;
an electrolyzer electrically connected to the solar panels;
a hydrogen tank coupled with the electrolyzer and configured to receive hydrogen created by the electrolyzer;
a hydrogen fuel cell coupled with the hydrogen tank and configured to receive hydrogen from the hydrogen tank, wherein the hydrogen fuel cell is electrically connected to the food cart; and
wherein the battery system is configured to provide electricity to the food cart.

7. The system of claim 6, wherein the electrolyzer is electrically connected to the solar panels via the battery system.

8. The system of claim 6, wherein the hydrogen fuel cell is electrically connected to the food cart via the battery system.

9. The system of claim 6, further comprising a solar converter disposed between the solar panels and the battery system, wherein the solar converter is configured to convert electricity generated by the solar panels into a form that the battery system can receive.

10. The system of claim 6, further comprising a power delivery converter disposed between the battery system and the food cart, wherein the power delivery converter is configured to convert electricity from the battery from direct current to alternating current.

11. The system of claim 6, wherein the solar panels are disposed on a roof of the food cart.

12. A sustainable food cart system comprising:
a food cart;
a set of solar panels;
a battery system electrically connected to the solar panels;
an electrolyzer electrically connected to the battery system;
a hydrogen tank coupled with the electrolyzer and configured to receive hydrogen created by the electrolyzer;
a hydrogen fuel cell coupled with the hydrogen tank and configured to receive hydrogen from the hydrogen tank, wherein the hydrogen fuel cell is electrically connected to the battery system; and
wherein the battery system is configured to provide electricity to the food cart.

13. The system of claim 12, further comprising a solar converter disposed between the solar panels and the battery system, wherein the solar converter is configured to convert electricity generated by the solar panels into a form that the battery system can receive.

14. The system of claim 12, further comprising a power delivery converter disposed between the battery system and the food cart wherein the power delivery converter is configured to convert electricity from the battery from direct current to alternating current.

15. The system of claim 12, wherein the solar panels are disposed on a roof of the food cart.
